(19) United States
(12) Patent Application Publication
(10) Pub. No.: US 2015/0247577 A1
(43) Pub. Date: Sep. 3, 2015

(54) DIVERTER VALVE CARTRIDGE PLATE

(71) Applicant: Idea Logic LLC, Somerset, NJ (US)

(72) Inventor: Andreas Balogh, Somerset, NJ (US)

(21) Appl. No.: 14/636,381

(22) Filed: Mar. 3, 2015

Related U.S. Application Data
(60) Provisional application No. 61/947,213, filed on Mar. 3, 2014.

(51) Int. Cl. F16K 1/46; F16K 25/00

(52) U.S. Cl. CPC F16K 1/465; F16K 25/005

(57) ABSTRACT

An improved diverter valve cartridge plate is disclosed. The plate may comprise a single, solid machined piece of material. The plat comprises a sealing portion integrated with a steel portion of plate to form a single integrated assembly. In an embodiment, the plate may be heat-treat hardened and may be hard-surface treated. In an embodiment, the plate may be coated. In an embodiment, the plate may be heat treat hardened stainless steel. In an embodiment, the plate may include a raised bridge area between port holes to mitigate or substantially eliminate a disc arm of the diverter valve from binding. In an embodiment, the plate may be sized and arranged to accommodate the form, fit and function of diverter valve plates for any sized diverter valve and for any size openings.

### CROSS-REFERENCE TO RELATED APPLICATIONS

This application claims the benefit of U.S. Provisional Application Ser. No. 61/947,213 filed Mar. 3, 2014, entitled “DIVERTER VALVE CARTRIDGE PLATE,” which is incorporated herein by reference in its entirety.

### BACKGROUND

1. Field

The following relates to pipeline diverter valves used in energy generation facilities such as coal sourced electric power plants and in particular to an improved diverter value cartridge plate.

2. Related Art

Energy generation facilities, for example, electric power plants utilizing coal as the energy source to be converted to electric power, employ a network of pipelines as conduits for the movement of liquids, powders, solids or gases, including steam to drive turbines to produce the electric power. Throughout this network of pipelines in the energy generation facilities, it is often necessary to divert liquid, powder, solids or gases, e.g., steam, from one pipeline to another. This is usually achieved by way of diverter valves, whereby the system will automatically (or through an operator) divert the flow of effluent from one pipeline to another at a diverter valve junction.

As can be appreciated, these diverter valves require proper seating or seals at the termination points of the pipelines to prevent leakage out of the valve discs of the diverter valve. Because the diverter valves include movable parts like shafts and discs, the plates on which the discs compress, will wear over time, requiring repair of the seats/seals or the installation of replaceable seat cartridges and insert rings. There are known problems in the field with existing valve designs, including pre-mature wear and tear as well as long and expensive shut-downs to repair/replace these parts of the valves, especially the seals or insert rings and possibly the cartridge plates themselves.

In known systems, the diverter valve plates comprise a plate sized and shaped to accommodate openings in the diverter valve, including groves or channels for receiving insert rings, gaskets or 0-rings (collectively “insert rings”). However, this type of design is plagued with pre-mature wear and tear causing earlier than expected leakage and thus down time for having to shut down the pipeline or worse the entire power plant when a failed insert ring is in need of replacement inside the diverter valve(s). Also, the insert rings have a tendency of popping out or cracking while in use. These failures of the seal plate can cause binding of the diverter valve disc and a failure to perform the diverter valve's function. This down time can be very expensive for electric power plants that are designed to provide nearly continuous power to their customers. In addition, the length of down time can also be a factor adding to the costs of being offline.

Thus, there is a need for an improved diverter valve seal plate that eliminates high failure rate parts causing pre-mature repair or replacement operations and relatively long down time to repair/replace parts in the diverter valve.

### SUMMARY

Embodiments of the present invention generally relate to an improved diverter valve cartridge plate (hereinafter “plate”). A diverter valve cartridge plate associated with a diverter valve comprising: a steel portion with a plurality of in-line openings, wherein the plurality of in-line opening are utilized for aligning with openings in the diverter valve; a plurality of grooves, wherein the plurality of grooves are formed around a circumference of the plurality of in-line opening; and a sealing portion fitted within the plurality of grooves to form a seal such that the sealing portion and the steel portion forms a single integrated assembly.

The plate may comprise a single, solid machined piece of material. In an embodiment, the plate may be heat-treat hardened. In an embodiment, the plate may be hard-surface treated. In an embodiment, the plate may be coated. In an embodiment, the plate may be heat treat hardened stainless steel. In an embodiment, the plate may include a raised bridge area between port holes to mitigate or substantially eliminate the disc arm of the diverter valve from being caught up. In an embodiment, the plate may be sized and arranged to accommodate the form, fit and function of diverter valve diverter valve and for any size openings.

Embodiments of the present invention include metallurgical and mechanical design improvements without necessarily changing form, fit and function of a diverter valve itself. Embodiments of the present invention provide for a plate that can be retrofitted in the same place, but with improved design for more durability to wear and stress. One advantage among many of embodiments of the present invention is that these designs tend to help with the elimination of the male plug of the diverter valve disk from getting stuck during transition between one pipeline opening to the next. During normal operation, the male plug slides back and forth from each hole (left or right), which is the way in which the effluent is diverted. When the plug sticks, it may cause leaking and pre-mature wear. The embodiments of the present invention substantially minimize that issue.

Other advantages include but are not limited to extending the overall diverter valve life cycle, reducing down time for maintenance, overall costs savings in parts and labor, and reduced risks of maintenance and replacement failure.

### BRIEF DESCRIPTION OF THE DRAWINGS

So the manner in which the above recited features of the present invention may be understood in detail, a more particular description of embodiments of the present invention, briefly summarized above, may be had by reference to embodiments, several of which are illustrated in the appended drawings.

Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1A depicts a known diverter valve plate with insert rings;

FIG. 1B depicts a side view of the diverter valve plate of FIG. 1A;

FIG. 1C depicts a diverter valve plate without insert rings;

FIG. 2 illustrates a perspective view of the diverter valve plate of FIG. 1;

FIG. 3A depicts a diverter valve cartridge plate in accordance with an embodiment of the present invention;

FIG. 3B depicts a side view of the diverter valve cartridge plate of FIG. 3A as an integrated assembly;

FIG. 4 illustrates a perspective view of the diverter valve cartridge plate of FIG. 3;

FIG. 5A depicts a diverter valve cartridge plate in accordance with an embodiment of the present invention, featuring an optional bolt mounting pattern;

FIG. 5B depicts a side view of the diverter valve cartridge plate of FIG. 5A as an integrated assembly; and

FIG. 6 illustrates a perspective view of the plate of FIG. 5.

The headings used herein are for organizational purposes only and are not meant to be used to limit the scope of the description or the claims. As used throughout this application, the word “may” is used in a permissive sense (meaning having the potential to), rather than the mandatory sense (meaning must). Similarly, the words “include,” “including,” and “includes” mean including but not limited to.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

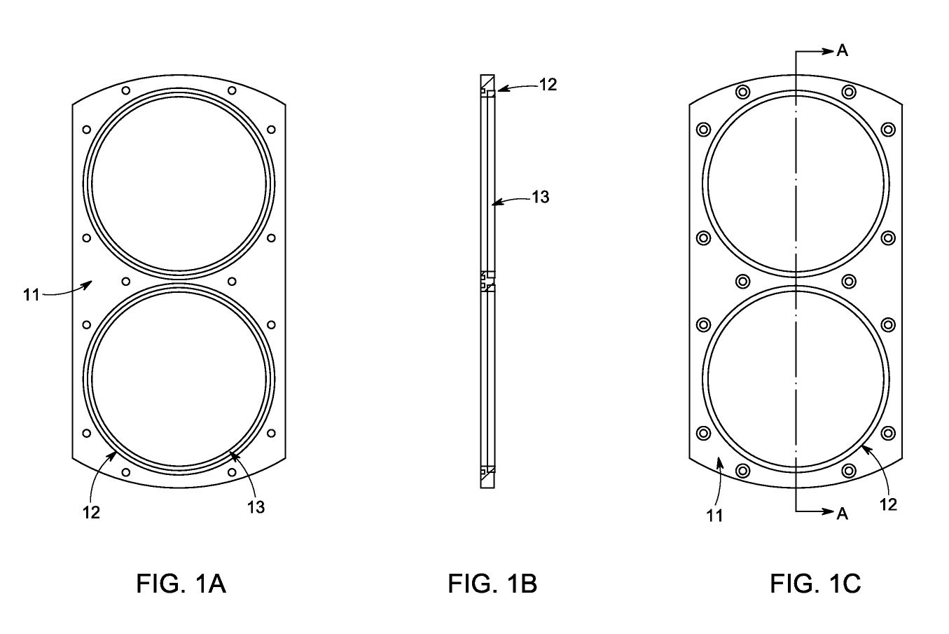

FIGS. 1A-1C describe a known diverter valve plate. FIG. 1A depicts a diverter valve plate 10 of a known design. The diverter valve plate 10 comprises a steel rectangular portion 11 having at least two in-line openings, for aligning with openings in a diverter valve. The plate 10 includes channels or groves 12 around the circumference of the in-line openings 11 for receiving, e.g., Stellite ring inserts 13. The inserts are designed to wear and be the sacrificial material of the seal for the diverter valve discs.

Further, a male plug (not shown) of the diverter valve may compress against the in-line openings of the diverter valve plate 10 and the Stellite inserts rings 13 will form the effluent tight seal. Due to the male plug moving between openings, the insert rings 13 will wear over time. Once it is determined that a seal is leaking or otherwise malfunctioning, the diverter valve has to go “off-line” and the failed insert rings 13 must be examined for wear, misalignment, tear and possible replacement.

FIG. 1B depicts the diverter valve cartridge plate from a side view. The insert rings 13 are placed in the grooves 12 to form the tight seal. Further, FIG. 1C depicts the diverter valve cartridge plate 10 without the insert rings 13. As shown in FIG. 1C, the diverter valve cartridge plate 10 comprises a rectangular plate 11 with two in-line openings and grooves 12 around the circumference of the two in-line openings. The insert rings 13 (not shown in FIG. 1C) will be received by the grooves 12.

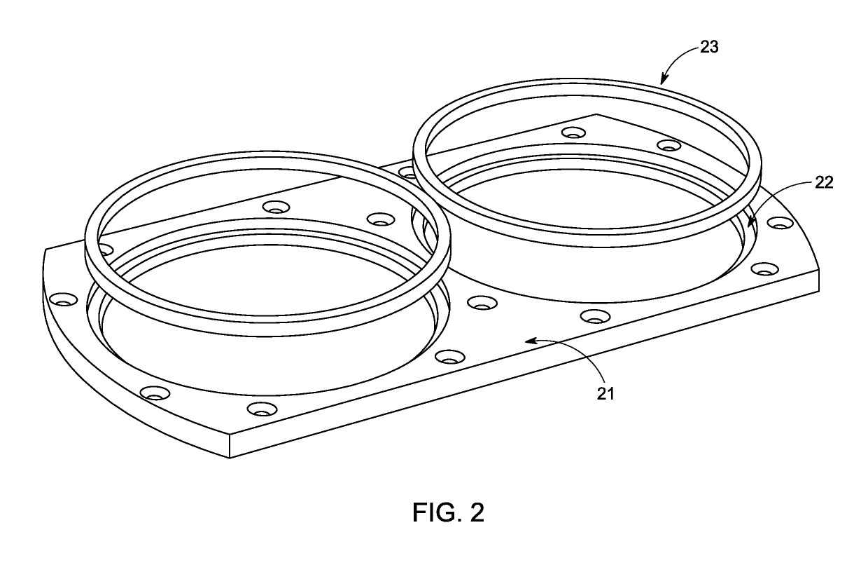

FIG. 2 is a perspective, exploded view of the diverter valve plate depicted in FIG. 1. FIG. 2 describes the rectangular steel portion 21 of the diverter valve plate. Here, the insert rings 23 can be seen prior to being inserted into the grooves or channels 22 of the rectangular steel portion 21. Once the insert rings 23 are installed, the plate with the insert rings 23 loaded is secured in the diverter valve for operation.

The type of design shown in FIGS. 1A-1C and FIG. 2 is plagued with pre-mature wear and tear causing earlier than expected leakage and thus down time for having to shut down the pipeline or worse the entire power plant when a failed insert ring is in need of replacement inside the diverter valve(s). Also, the insert rings have a tendency of popping out or cracking while in use. These failures of the seal plate can cause binding of the diverter valve disc and a failure to perform the diverter valve's function. This down time can be very expensive for electric power plants that are designed to provide nearly continuous power to their customers. In addition, the length of down time can also be a factor adding to the costs of being offline.

In order to overcome the aforementioned problems, embodiments in accordance with the present invention describe a diverter valve cartridge plate associated with the diverter valve comprising a steel portion with a plurality of in-line openings, wherein the plurality of in-line opening are utilized for aligning with openings in the diverter valve; a plurality of grooves, wherein the plurality of grooves are formed around a circumference of the plurality of in-line opening; and a sealing portion fitted within the plurality of grooves to form a seal such that the sealing portion and the rectangular steel portion forms a single integrated assembly.

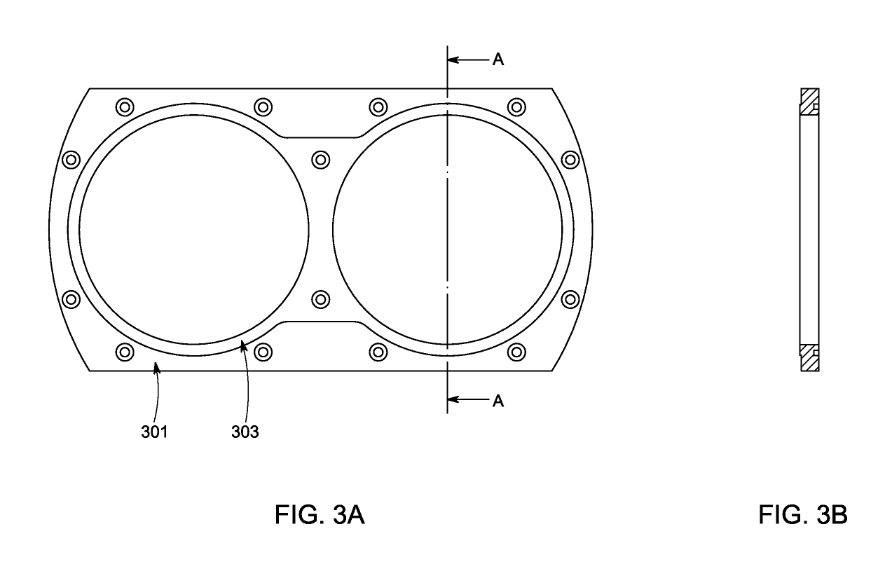

FIG. 3A describes a diverter valve cartridge plate 300 in accordance with an embodiment of the present invention. The diverter valve cartridge plate 300 includes a steel portion 301 comprising two in-line opening. One of the two in-line openings receives a plug of the diverter valve. Further, the diverter valve cartridge plate includes a sealing portion 303 integrated with the steel portion 301 through the grooves 302 (not shown). The sealing portion 303 and the steel portion 301 are integrated to form a single assembly. With the single fixed design of the diverter valve cartridge plate 300, the problem of male plugs of the diverter valve being stuck with the seal in the prior art is substantially eliminated during the transition of the male plug from first in-line opening to the next.

FIG. 3B depicts a side view of the diverter valve cartridge plate, in accordance with an embodiments of the present invention. As shown in FIG. 3B, the sealing portion is integrated with the steel portion of the diverter valve cartridge plate 300 to form a fixed seal for the diverter valve.

During normal operation, the male plug of the diverter valve slides back and forth from one in-line opening of the steel portion 301 to the second in-line opening of the rectangular steel portion 301 (left or right), to divert the flow of an effluent from one direction to other direction. With the plate design described in embodiments of the present invention, the issue of the male plug of the diverter valve sticking with the seal, resulting in leaking and pre-mature wear, is substantially minimized.

In an embodiment of the present invention, the sealing portion 303 of the diverter valve cartridge plate 300 is integrated with the steel portion 301 of the diverter valve cartridge plate 300 by means of bolts, as shown in FIG. 3A. Further, it should be appreciated that modifications in the dimensions of the steel portion, the in-line openings, and the sealing portion of the diverter valve cartridge plate 300 may be isometrically enlarged or reduced to geometrically and/or congruently fit any new diverter valve or replace any size diverter valve cartridge plate currently in the field in order to perform with the same form, fit and function.

The embodiment shown in FIG. 3A may include all heat-treatable alloys to their maximum hardness, including, but not limited, to steel alloys, nickel alloys, stainless steels and including, but not limited to, stainless steel. Other embodiments of the present invention include but are not limited to alternatives to hardened alloys. For example, the plate may comprise hard-surface overlaying to all partial parts of the plate nitriding, carburizing, hard-plating, cladding, surface peening, surface impregnating or any variety of metal surface coatings and their applications.

In another embodiment of the present invention, the diverter valve cartridge plate 300 may include a raised bridge area between in-line openings of the rectangular portion 301 of the diverter valve cartridge plate 300. The raised bridge area is utilized to mitigate or substantially eliminate the problem of a disc arm of the diverter valve from being caught up. The width of the raised bridge area between the in-line openings may vary based on the size of the corresponding diverter valve.

In another embodiment of the present invention, the diverter valve cartridge plate 300 may be sized and arranged to accommodate the form, fit and function of diverter valve and for any size openings.

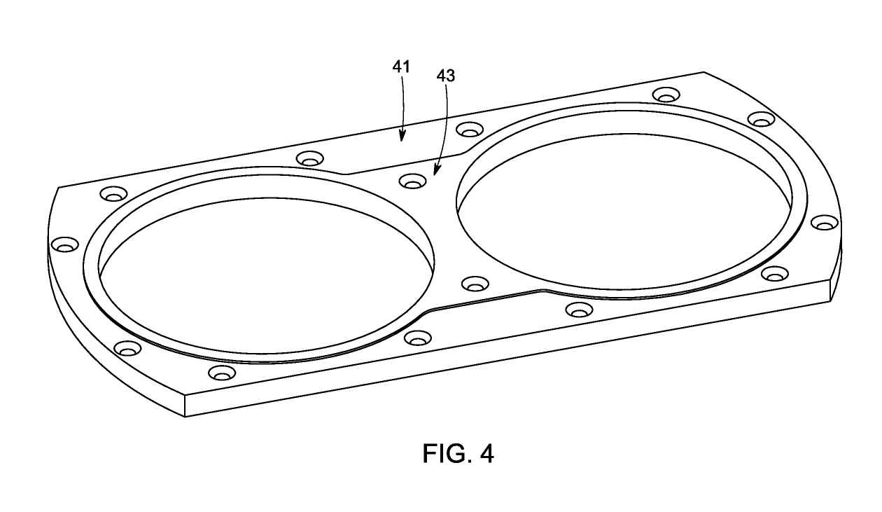

FIG. 4 depicts a perspective view of the diverter vale cartridge plate 400 as described in FIG. 3 in accordance with an embodiment of the present invention. Referring to FIG. 4, the integrated sealing portion 403 is readily visible around the circumference of the in-line openings of the rectangular steel portion of the diverter valve cartridge plate 401. As can be seen from FIG. 4, there is no need for separate insert rings like in the diverter valve plates shown in FIG. 1. As evident from FIG. 4, the sealing portion 403 is integrated with the steel portion 401 of the diverter valve cartridge plate 400 by any means, including seal fitted, fused, or bolts.

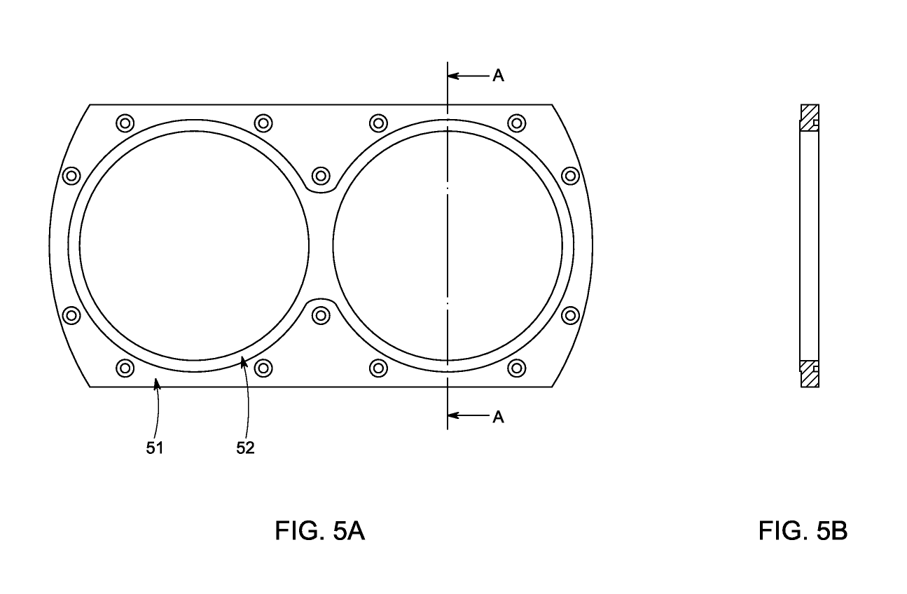

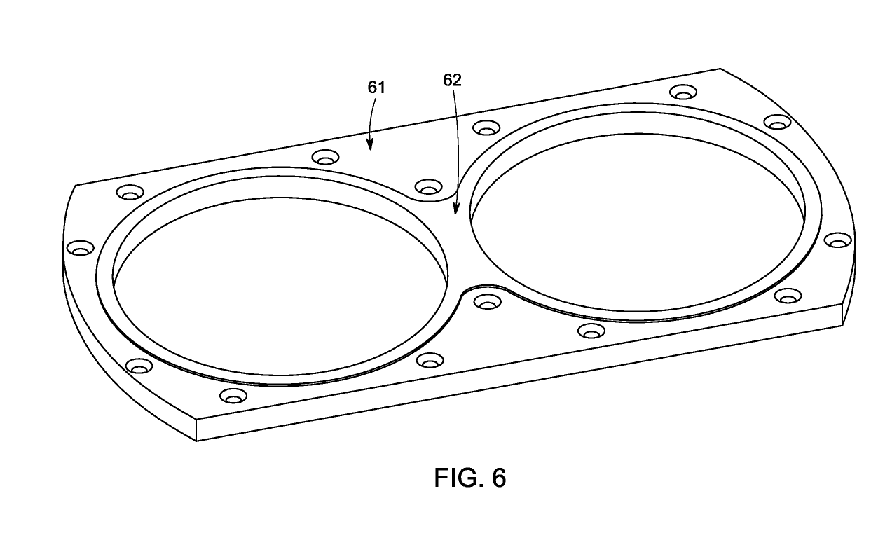

Further, FIGS. 5 and 6 represent another embodiment of the present invention. FIGS. 5 and 6 are a variation to the embodiment shown in FIGS. 3 and 4. Here, an optional bolt mounting pattern is included in this embodiment. The materials and other aspects of this embodiment are similar to those described in relations to the embodiments of FIGS. 3 and 4.

The variation of the bolt mounting pattern is provided to justify the size of the disc-plug which will be reciprocating from left to right. Each OEM and their various sizes of valves will determine the need for a “narrow” or “wide” bridge between port-holes. For example, larger design disc-plugs will work more efficiently if a wider bridge is present, to limit side-to-side slide resistance. Smaller designs will work fine with a “narrow” bridge, which reduces overall plate weight, lower manufacturing costs and make maintenance/removal somewhat easier. In essence there are at least two bridge designs: light-duty and heavy-duty.

It will be understood that there are numerous modifications of the illustrated. embodiments described above which will be readily apparent to one skilled in the art, such as variations and modifications of the valve assembly and/or its components, including combinations of features disclosed herein that are individually disclosed or claimed herein, explicitly including additional combinations of such features, or alternatively other types of valve assemblies. For example, valve assemblies can have more than one first fluid pathway or more than one selection member or housing. Also, there are many possible variations in the materials and configurations. These modifications and/or combinations fall within the art to which this disclosure relates and are intended to be within the scope of the claims, which follow.

As utilized herein, the terms “approximately,” “about/” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the orientation of various elements may differ according to other exemplary embodiments, and that such variations are intended to be encompassed by the present disclosure.

It is also important to note that the construction and arrangement of the valve assembly as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, §6, and any claim without the word “means” is not so intended.

What is claimed is:

1. A diverter valve cartridge plate to accommodate opening in a diverter valve comprising:
a steel portion with a plurality of in-line openings, wherein the plurality of in-line opening are utilized for aligning with openings in the diverter valve;
a plurality of grooves, wherein the plurality of grooves are formed around a circumference of the plurality of in-line opening; and
a sealing portion fitted within the plurality of grooves to form a seal such that the sealing portion and the steel portion forms a single integrated assembly.

2. The diverter valve cartridge plate of claim 1, wherein the diverter valve cartridge plate is designed to form a single, solid machined piece of material.

3. The diverter valve cartridge plate of claim 1, further comprising a raised bridge area between the plurality of in-line openings to mitigate interference witha disc arm of a diverter valve.

4. The diverter valve cartridge plate of claim 3, wherein the width of the raised bridge area is a function of the size of a diverter valve.

5. The diverter valve cartridge plate of claim 1, wherein the diverter valve cartridge plate is sized and arranged to accommodate the form, fit and function of diverter valve plates for any sized diverter valve and for any size openings.

6. The diverter valve cartridge plate of claim 1, wherein the diverter valve cartridge plate is made from heat treatable hardened alloys.

7. The diverter valve cartridge plate of claim 1, wherein the diverter valve cartridge plate is hard surface treated.

8. The diverter valve cartridge plate of claim 1, wherein the diverter valve cartridge plate is coated.

9. The diverter valve cartridge plate of claim 1, wherein the diverter valve cartridge plate is heat treat hardened stainless steel.

10. The diverter valve cartridge plate of claim 1, wherein at least one of the plurality of in-line openings receives a male plug of a disk in a diverter valve.

11. The diverter valve cartridge plate of claim 10, wherein the diverter valve cartridge plate is shaped and configured to allow the male plug of the diverter disk slides back and forth among the plurality of the in-line opening to divert material flowing through the diverter valve.

12. The diverter valve cartridge plate of claim 1, wherein the sealing portion is integrated with the steel portion.

13. The diverter valve cartridge plate of claim 1, wherein the sealing portion acts as the fixed insert rings and additional insert rings are not required.
